(19) United States
(12) Patent Application Publication
(10) Pub. No.: US 2025/0015732 A1
(43) Pub. Date: Jan. 9, 2025

(54) METHOD OF GENERATING ELECTRICAL ENERGY BY IMPACTING PIEZOELECTRIC ELEMENT

(71) Applicant: Adebayo AKINBI, Agege Lagos (NG)

(72) Inventor: Adebayo AKINBI, Agege Lagos (NG)

(21) Appl. No.: 18/576,323

(22) PCT Filed: Jul. 5, 2021
(86) PCT No.: PCT/IB2021/055993

§ 371 Date: Jan. 3, 2024

(51) Int. Cl. H02N 2/18; F01D 15/10

(52) U.S. Cl. CPC H02N 2/183; F01D 15/10; F05D 2220/76

(57) ABSTRACT

The disclosed method of generating electrical energy uses a body (36) set in reciprocating motion (M5, M6) to and from a piezoelectric element (22) such that the body is caused to make impact and apply pressure (F56) on the piezoelectric element, thereby developing electrical charge which is collected as electrical energy from the electrodes of the piezoelectric element. A reciprocating mechanism (32), for example, a crank mechanism including rotating member (34) and reciprocating member (36), to convert rotating motion into reciprocating motion, and a gear train (52) for changing input rotational speed, can be included.

### TECHNICAL FIELD

The present invention relates to a method of generating electrical energy from piezoelectricity.

### BACKGROUND ART

Electricity has been a very useful form of energy to humans for many years for ease of doing work, luxury, development and better livelihood. Conventionally, the most common method of generating electrical energy is through electromagnetism as seen in electromagnetic generators, which are run by renewable and non renewable sources of force for rotating generator shafts. The closest other common means of generating electrical energy is through the photovoltaic effect as seen in the use of solar panels.

Problems of generating electrical energy in the present world today are with the consumption of fossil fuel sources, which are non renewable finite amounts of fuel and pose great threats to nature, as enormous amounts of greenhouse gases are expelled when these fuels are combusted to power large electric generators. Some renewable energy methods of generating electrical energy also have their drawbacks as seen in the use of solar panels, which are clean but space consuming due to form factor, location dependent and limited to daylight usage.

Piezoelectricity is a phenomenon that causes certain materials to develop electrical charge when mechanical stress is applied to them. Naturally occurring crystalline compounds such as quartz have been observed to be electrically polarized when mechanical stress or pressure is applied to them. Materials have been developed such as the common Lead Zirconate Titanate (PZT) to harness electrical energy production through piezoelectricity.

Energy harvesting methods have utilized the piezoelectric effect in order to produce electrical energy from mechanical stress or pressure. This can be regarded as a form of renewable energy as the process of generation is pollution free. Examples can be seen in devices created to harness mechanical stress from footsteps of individuals when walking and vehicles driving over such devices. However, Energy harvesting with piezoelectricity is only targeted at scavenging ambient energy for providing small amounts of power for running low energy electronics.

WO/2011/148369 describes energy harvesting through piezoelectricity, which involves a stack of piezoelectric elements harvesting mechanical stress from rail tracks, which is also clean but also location dependent as mentioned above.

In these respects, the method of generating electrical energy according to the present invention substantially departs from the conventional methods of energy generation and harvesting and, in doing so provides an option for energy generation that is renewable, reuses source energy efficiently, of lesser form factor during use and non dependent on location and time of day.

### Disclosure of Invention

In view of the foregoing disadvantages inherent in the known types of electrical energy generation methods now present in the prior art, the present invention provides a new method of generating electrical energy.

The general purpose of the present invention, which will be described subsequently in greater detail, is to provide a new method of generating electrical energy which has advantages over current methods of producing electrical energy, and novel features that result in a new electrical energy generation method which is not anticipated, rendered obvious, suggested, or even implied by any of the prior art electrical energy generation methods, either alone or in any combination thereof.

To achieve this, the present invention generally comprises a piezoelectric element which develops electric charge in response to applied pressure, and a body set in reciprocating motion to and from the piezoelectric element (having reciprocating momentum as a result of the mass of the body and its velocity), which applies pressure on said piezoelectric element by making impact with it, and collecting generated energy from positive and negative electrodes of the piezoelectric element.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The object of the present invention is to provide a method of generating electrical energy that will overcome the shortcomings of the prior art.

A second object is to provide a method of generating electrical energy that reuses the same input energy among several piezoelectric elements thus maximising usage of source energy.

Another object is to provide a method of generating electrical energy that could offer options for a lower form factor during usage than other known renewable forms of electrical energy generation.

A further object is to provide a method of generating electrical energy that improves the usage of piezoelectricity for generation of electrical energy.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. The invention is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale. For clarity, non-essential elements were omitted from some of the drawings.

In the drawings:

FIG. 1 is a front view of a first embodiment of the invention.

FIG. 2 is a front view of a second embodiment of the invention.

FIG. 3 is a front view of a third embodiment of the invention.

FIG. 4 is a front view of a fourth embodiment of the invention.

FIG. 5 is a front view of a fifth embodiment of the invention.

FIG. 6 is a front view of a sixth embodiment of the invention.

### DETAILED DESCRIPTION OF THE INVENTION

A method of generating electrical energy is disclosed herein. As described below, the process generally involves causing a body to reciprocate and make impact with a piezoelectric element thereby causing electrical charge to develop in the piezoelectric element, and collecting the electrical charges from the positive and negative electrodes of the piezoelectric element. The method of this invention utilizes impact to apply pressure on piezoelectric elements which has a greater effect than compressive stress which is used by other known methods of generating electrical energy from piezoelectricity.

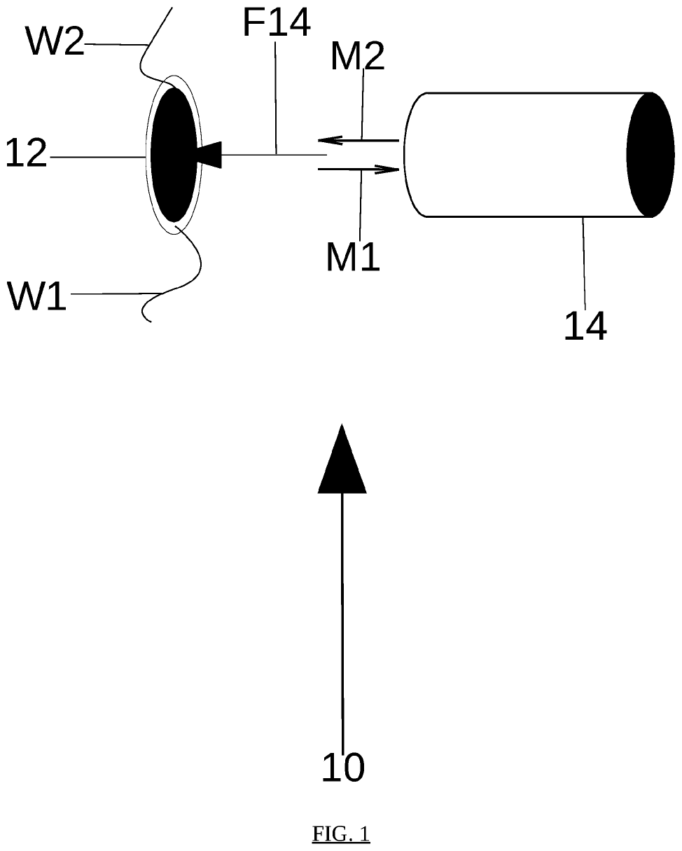

Referring now to the drawings in which like reference numerals designate like or corresponding parts throughout the several views, there is shown in FIG. 1 an embodiment 10 of the present invention whose method of generating electrical energy begins with causing the body 14 to be in reciprocating motion in the directions M1 and M2 to and from piezoelectric element 12 and to make impact with the piezoelectric element 12 thus applying pressure F14 to it thereby causing electrical charge to develop in the piezoelectric element 12. The developed electrical charge is then collected as electrical energy via electrical conductors for example wires W1 and W2 connected to the positive and negative electrodes of the piezoelectric element 12.

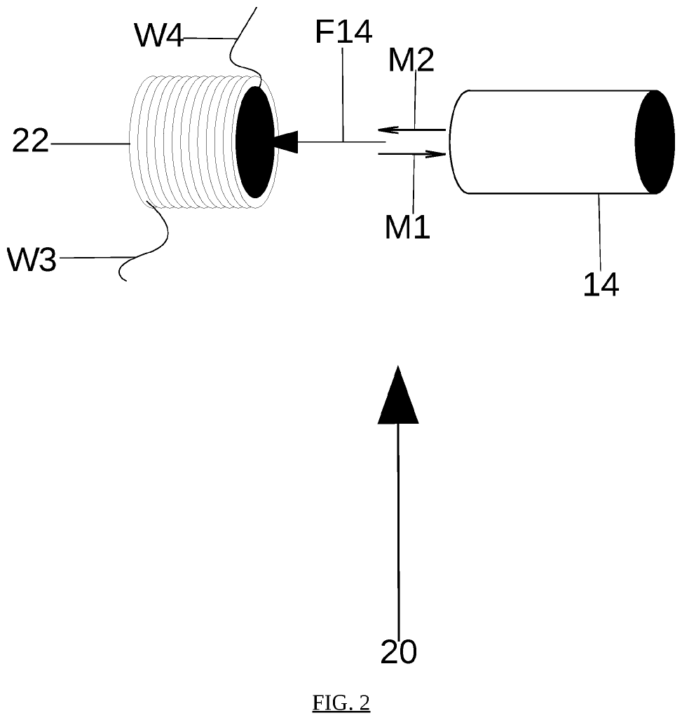

Referring now to FIG. 2, a second embodiment 20 of the present invention is illustrated. In this case the body 14 is caused to be in reciprocating motion in the directions M1 and M2 to and from a stack including a plurality of piezoelectric elements 22 and to make impact with the stack 22 thus applying the same pressure F14 that was used for a piezoelectric element 12 of embodiment 10 on a plurality of piezoelectric elements in stack 22 of embodiment 20 and providing more electrical energy from the same pressure applied in embodiment 10 after causing electrical charge to develop in the piezoelectric elements of the stack 22. The developed electrical charges are then collected as electrical energy via electrical conductors for example wires W3 and W4 connected to the positive and negative electrodes of piezoelectric elements in stack 22.

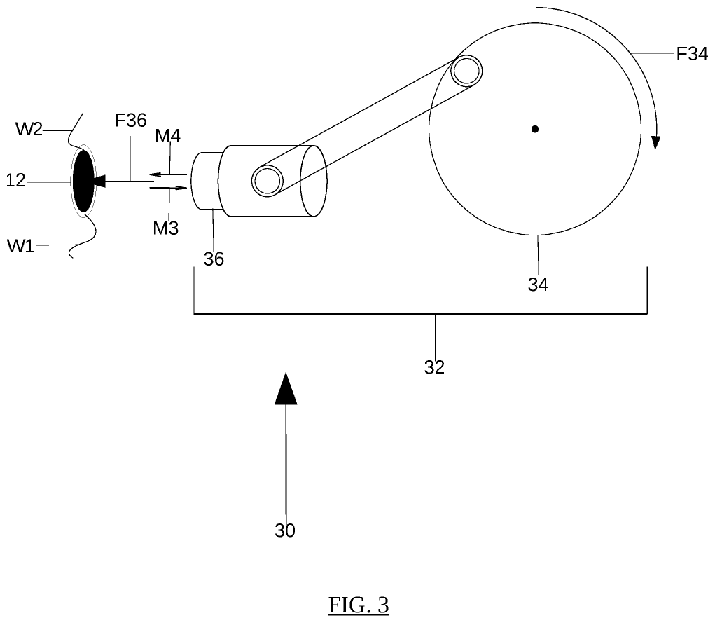

Referring now to FIG. 3, a third embodiment 30 of the present invention is illustrated. A reciprocating mechanism 32 for example a crank mechanism, including rotating member 34 and reciprocating member 36, which converts rotating motion into reciprocating motion is included this time in order to produce several instances of reciprocating motion, thus producing several instances of impact. The body 14 with reciprocating motion in embodiments 10 and 20 is replaced with the reciprocating member 36 of reciprocating mechanism 32. The embodiment 30 begins by continuously applying a force F34 directly or indirectly from a source which could be an elastic material returning to its natural state, heat engine or a turbine, to set rotating member 34 in continuous rotation. Reciprocating mechanism 32 then converts rotational motion in 34 to continuous reciprocating motion in 36 in the directions M3 and M4 to and from piezoelectric element 12. Reciprocating member 36 being set in continuous reciprocating motion is caused to make several impacts with the piezoelectric element 12 thus applying pressure F36 to it thereby causing electrical charge to develop in the piezoelectric element 12. The developed electrical charge is then collected as electrical energy via electrical conductors for example wires W1 and W2 connected to the positive and negative electrodes of the piezoelectric element 12.

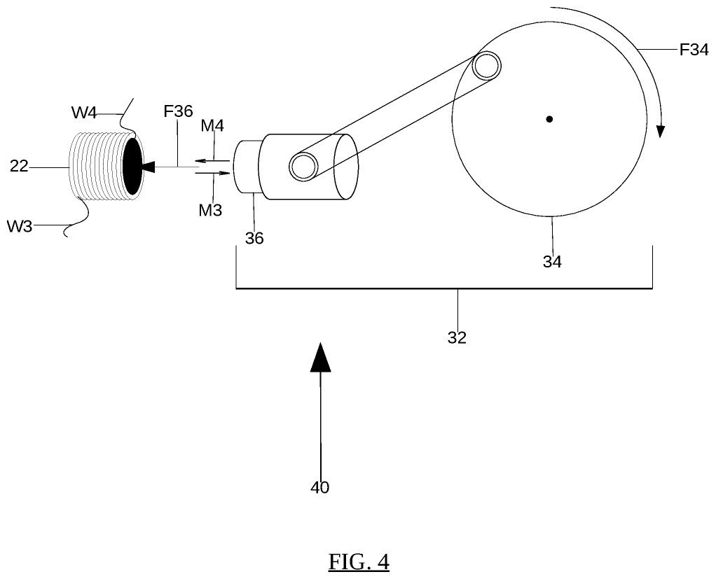

A fourth embodiment 40 of the present invention is illustrated in FIG. 4. A reciprocating mechanism 32 for example a crank mechanism, including rotating member 34 and reciprocating member 36, which converts rotating motion into reciprocating motion is included this time in order to produce several instances of reciprocating motion, thus producing several instances of impact in like fashion as embodiment 30. The body 14 with reciprocating motion in embodiments 10 and 20 is replaced with the reciprocating member 36 of reciprocating mechanism 32. The embodiment 40 begins by continuously applying a force F34 directly or indirectly from a source which could be an elastic material returning to its natural state, heat engine or a turbine, to set rotating member 34 in continuous rotation. Reciprocating mechanism 32 then converts rotational motion in 34 to continuous reciprocating motion in 36 in the directions M3 and M4 to and from a stack including a plurality of piezoelectric elements 22. Reciprocating member 36 being set in continuous reciprocating motion is caused to make several impacts with the stack 22 thus applying the same pressure F36 that was used for a piezoelectric element 12 of embodiment 30 on a plurality of piezoelectric elements in stack 22 of embodiment 40 and providing more electrical energy from the same pressure applied in embodiment 30. The developed electrical charges are then collected as electrical energy via electrical conductors for example wires W3 and W4 connected to the positive and negative electrodes of piezoelectric elements in stack 22.

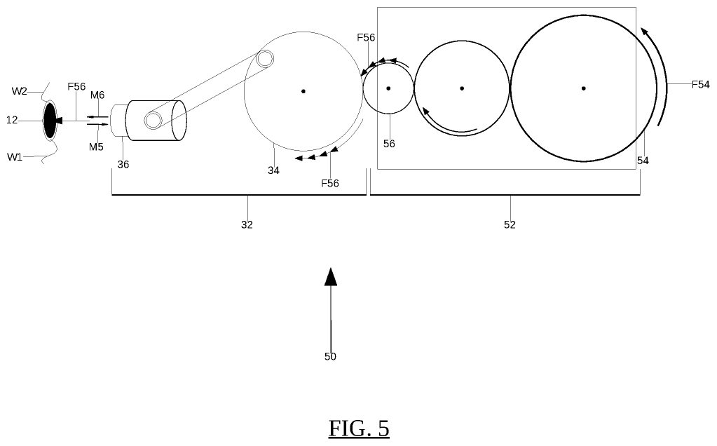

A fifth embodiment 50 of the present invention is illustrated in FIG. 5. A machine for changing input rotational speed to a different output rotational speed 52 for example a gear train, including input member 54 and output member 56 is included this time in order to increase or decrease the rotational speed caused by an external force. The embodiment 50 begins by continuously applying a force F54 directly or indirectly from a source which could be an elastic material returning to its natural state, heat engine or a turbine, to set input member 54 in continuous rotation. The machine 52 then changes the input rotational speed in 54 to a larger output rotational speed in 56. The output member 56 then drives the rotating member 34 continuously with output force from F56. Reciprocating mechanism 32 then converts rotational motion in 34 to continuous reciprocating motion in 36 in the directions M5 and M6 to and from piezoelectric element 12. Reciprocating member 36 being set in continuous reciprocating motion is caused to make several impacts with the piezoelectric element 12 thus applying pressure F56 to it thereby causing electrical charge to develop in the piezoelectric element 12. The developed electrical charge is then collected as electrical energy via electrical conductors for example wires W1 and W2 connected to the positive and negative electrodes of the piezoelectric element 12.

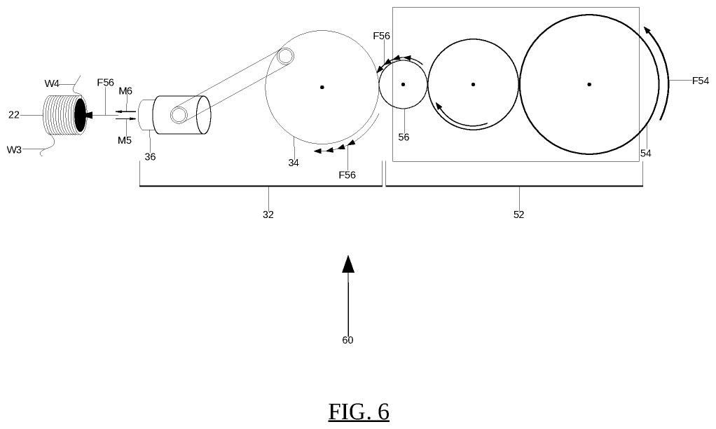

A sixth and preferred embodiment 60 of the present invention is illustrated in FIG. 6. A machine for changing input rotational speed to a different output rotational speed 52 for example a gear train, including input member 54 and output member 56 is included this time in order to increase or decrease the rotational speed caused by an external force, in like fashion as embodiment 50. The embodiment 60 begins by continuously applying a force F54 directly or indirectly from a source which could be an elastic material returning to its natural state, heat engine or a turbine, to set input member 54 in continuous rotation. The machine 52 then changes the input rotational speed in 54 to a larger output rotational speed in 56. The output member 56 then drives the rotating member 34 continuously with output force from F56. Reciprocating mechanism 32 then converts rotational motion in 34 to continuous reciprocating motion in 36 in the directions M5 and M6 to and from a stack including a plurality of piezoelectric elements 22. Reciprocating member 36 being set in continuous reciprocating motion is caused to make several impacts with the stack 22 thus applying the same pressure F56 that was used for a piezoelectric element 12 of embodiment 50 on a plurality of piezoelectric elements in stack 22 of embodiment 60 and providing more electrical energy from the same pressure applied in embodiment 50. The developed electrical charges are then collected as electrical energy via electrical conductors for example wires W3 and W4 connected to the positive and negative electrodes of piezoelectric elements in stack 22.

1. A method of generating electrical energy having at least a piezoelectric element and at least a body, said method comprising the steps of:
causing said body to reciprocate to and from said piezoelectric element and make direct or indirect mechanical impact with said piezoelectric element; and
collecting electrical energy generated as a result of said mechanical impact from positive and negative electrodes of said piezoelectric element.

2. A method of generating electrical energy having at least a stack including a plurality of piezoelectric elements and at least a body, said method comprising the steps of:
causing said body to reciprocate to and from said stack and make direct or indirect mechanical impact with said stack; and
collecting electrical energy generated as a result of said mechanical impact from positive and negative electrodes of piezoelectric elements in said stack.

3. The method of generating electrical energy of claim 1, wherein said body is at least one reciprocating member of at least one reciprocating mechanism, whose said reciprocation to and from said piezoelectric element and said mechanical impact with said piezoelectric element is caused by the rotation of at least one rotating member of said reciprocating mechanism.

4. The method of generating electrical energy of claim 2, wherein said body is at least one reciprocating member of at least one reciprocating mechanism, whose said reciprocation to and from said stack and said mechanical impact with said stack is caused by the rotation of at least one rotating member of said reciprocating mechanism.

5. The method of generating electrical energy of claim 3, including the step of driving said rotating member with direct or indirect force from at least one elastic material returning to its natural state after being distorted by external force.

6. The method of generating electrical energy of claim 4, including the step of driving said rotating member with direct or indirect force from at least one elastic material returning to its natural state after being distorted by external force.

7. The method of generating electrical energy of claim 5, wherein said elastic material is an elastic material selected from the group consisting of rubber, artificial muscle, alloy, polymer, composite material, fibre, and metal.

8. The method of generating electrical energy of claim 6, wherein said elastic material is an elastic material selected from the group consisting of rubber, artificial muscle, alloy, polymer, composite material, fibre, and metal.

9. The method of generating electrical energy of claim 3, including the step of driving said rotating member with direct or indirect force from at least one working heat engine.

10. The method of generating electrical energy of claim 4, including the step of driving said rotating member with direct or indirect force from at least one working heat engine.

11. The method of generating electrical energy of claim 9, wherein said heat engine is a heat engine selected from the group consisting of internal combustion engine and external combustion engine.

12. The method of generating electrical energy of claim 10, wherein said heat engine is a heat engine selected from the group consisting of internal combustion engine and external combustion engine.

13. The method of generating electrical energy of claim 3, including the step of driving said rotating member with direct or indirect force from at least one working turbine.

14. The method of generating electrical energy of claim 4, including the step of driving said rotating member with direct or indirect force from at least one working turbine.

15. The method of generating electrical energy of claim 13, wherein said turbine is a turbine selected from the group consisting of steam turbine, statorless turbine, bladeless turbine, Tesla turbine, water turbine and wind turbine.

16. The method of generating electrical energy of claim 14, wherein said turbine is a turbine selected from the group consisting of steam turbine, statorless turbine, bladeless turbine, Tesla turbine, water turbine, and wind turbine.

17. The method of generating electrical energy of claim 3, including the step of directly or indirectly driving said rotating member with force from at least one output member of at least one machine for changing input rotational speed to a different output rotational speed which is being powered by an external force via at least one input member of said machine.

18. The method of generating electrical energy of claim 4, including the step of directly or indirectly driving said rotating member with force from at least one output member of at least one machine for changing input rotational speed to a different output rotational speed which is being powered by an external force via at least one input member of said machine.

19. The method of generating electrical energy of claim 17, including the step of driving said input member of said machine with direct or indirect force from at least one elastic material returning to its natural state after being distorted by external force.

20. The method of generating electrical energy of claim 18, including the step of driving said input member of said machine with direct or indirect force from at least one elastic material returning to its natural state after being distorted by external force.

21. The method of generating electrical energy of claim 19, wherein said elastic material is an elastic material selected from the group consisting of rubber, artificial muscle, alloy, polymer, composite material, fibre, and metal.

22. The method of generating electrical energy of claim 20, wherein said elastic material is an elastic material selected from the group consisting of rubber, artificial muscle, alloy, polymer, composite material, fibre, and metal.

23. The method of generating electrical energy of claim 17, including the step of driving said input member of said machine with direct or indirect force from at least one working heat engine.

24. The method of generating electrical energy of claim 18, including the step of driving said input member of said machine with direct or indirect force from at least one working heat engine.

25. The method of generating electrical energy of claim 23, wherein said heat engine is a heat engine selected from the group consisting of internal combustion engine and external combustion engine.

26. The method of generating electrical energy of claim 24, wherein said heat engine is a heat engine selected from the group consisting of internal combustion engine and external combustion engine.

27. The method of generating electrical energy of claim 17, including the step of driving said input member of said machine with direct or indirect force from at least one working turbine.

28. The method of generating electrical energy of claim 18, including the step of driving said input member of said machine with direct or indirect force from at least one working turbine.

29. The method of generating electrical energy of claim 27, wherein said turbine is a turbine selected from the group consisting of steam turbine, statorless turbine, bladeless turbine, Tesla turbine, water turbine, and wind turbine.

30. The method of generating electrical energy of claim 28, wherein said turbine is a turbine selected from the group consisting of steam turbine, statorless turbine, bladeless turbine, Tesla turbine, water turbine, and wind turbine.
